(19) United States
(12) Patent Application Publication
(10) Pub. No.: US 2005/0289567 A1
(43) Pub. Date: Dec. 29, 2005

(54) Method And Apparatus For Controlling A Disc Loader Of An Optical Disc Drive

(76) Inventors: Yu-Hung Sun, Taipei City (TW); Chih-Hau Chang, Taipei City (TW)

Correspondence Address: NORTH AMERICA INTELLECTUAL PROPERTY CORPORATION, P.O. BOX 506, MERRIFIELD, VA, 22116, US

(21) Appl. No.: 10/710,162

(22) Filed: Jun. 23, 2004

(51) Int. Cl. G11B 17/03; G11B 17/04; G11B 33/02

(52) U.S. Cl. 720/610

(57) ABSTRACT

A specific control method, for inclusion as part of a holistic optical disc drive control method for those optical disc drive types fitted with an emergency release mechanism. This method having control steps to determine whether disc access operations are in progress, whether inappropriate use has been made of the optical disc drive emergency release mechanism, and to initiate remedial action in the case that both of the former conditions are true.

### BACKGROUND OF INVENTION

1. Field of the Invention

The invention relates to a method and apparatus for an optical disc drive, and in particular to a method and apparatus for controlling the disc loader of the optical disc drive in the case of inappropriate use of an emergency release facility.

2. Description of the Prior Art

Optical disc drives are becoming more popular in the market, and have been considered standard equipment on personal computers for several years. Generally speaking, optical disc drives are used to read information stored on an optical disc. Examples of optical disc drives are known as compact disc drives (CD-ROM drives) and digital versatile disc drives (DVD-ROM drives) in the prior art. Some optical disc drives have the additional capability of being able to write data onto an optical disc, i.e., CD-R/RW, DVD+R/RW and DVD-R/RW drivers. Optical disc drives are used in music and video playback and are implemented in recording devices and other electronic devices.

One type of optical disc drive is intended to be fitted to the chassis of a host computer's casing (often referred to as an internal type drive), access to the disc drive's fascia generally being available on the front panel of the host computer's casing. Because of packaging constraints and the need to offer accommodation for other drives and devices, space within the host computers casing is often limited, therefore a low profile package design is a desirable attribute for optical disc drives.

FIG. 1 illustrates the fascia of a conventional internal optical disc drive, comprising an optical disc loader front plate 11, a fascia panel 12, the fascia panel 12 further comprising an open/close request button 13, an earphone socket 14 and an opening 15. With a limited area of fascia to present to the user, optical disc drives generally utilize a drawer style optical disc loader, that is, a motorized tray designed to accommodate various sizes of optical disc, that slides horizontally outward from and inward to the optical disc drive unit, in order to eject or load an optical disc.

FIG. 2 is a partially exploded isometric view of the conventional internal optical disc drive 10 of FIG. 1 with disc loader front panel 11 and fascia panel 12 removed for clarity and comprises an optical disc loader 21, a housing 22, a traverse 23, a motor 29 and additionally a top cover 24, a control electronics PCB 25 and a plate 26, detached for clarity. The optical disc loader 21 further comprises a recess 28, and the plate 26 further comprises a sensor 27.

The optical disc loader 21, being slidably mounted on the housing 22 and driven by the motor 29, features a recess 28 for accommodating an optical disc and is seen here partially extended towards its fully open position, and the traverse 23 shown in its lowered position. Because, in this type of drive, the optical disc loader 21 is designed to slide independently of the traverse 23, the transport mechanism 23 must be allowed a range of vertical movement so that it can be lowered to prevent collision with the optical disc loader 21. Indeed, these relative modes of movement are mechanically interlocked as described below, so as to be mutually exclusive. The sensor 27 is for detection purposes.

FIG. 3 is a perspective view of the optical disc drive of FIG. 2 with top cover 24, control electronics PCB 25 and plate 26 removed for clarity and comprises an optical disc loader 21, a housing 22, a traverse 23, further comprising flexible mountings 31, an optical pick-up head 37, a sledge motor 38 and a spindle motor assembly 34, and additionally a hinged linkage 32 and an up/down bar 33. The spindle motor assembly 34, further comprises an optical disc boss 35 and a spindle motor 36.

The optical disc loader 21 is seen in the fully open position, that is, at its maximum extension within normal mechanical limits, this being a position which would permit deposition or removal of an optical disc. The traverse 23, being mounted on the housing 22 via flexible mountings 31 at the rear (FIGS. 3 & 4 are views from the rear of the optical disc drive 10), and on a hinged linkage 32 via further flexible mountings 31 at the front, the hinged linkage 32 in turn being pivotally mounted on the housing 22, is seen at the lowermost extent of its vertical travel. Mounted on the traverse 23 is a spindle motor assembly 34, which in turn generally comprises an optical disc boss 35 to accommodate an optical disc, and a motor 36 to rotate the optical disc boss.

The main component responsible for coordinating relative movement between the optical disc loader 21 and the traverse 23 is the up/down bar 33, which is so called because of its relationship with the latter. The hinged linkage 32 is constantly engaged in oblique slots formed in the up/down bar 33, thus determining a relationship between the horizontal position of the up/down bar 33, the hinged linkage 32 and hence the traverse 23. The slidably mounted up/down bar 33 forms a direct physical link between the optical disc loader 21, the hinged linkage 32 and hence the traverse 23, when the optical disc loader 21 is at the fully closed position by engaging the optical disc loader 21, and being designed in such a way that the optical disc loader 21 remains locked throughout the portion of the up/down bar's 33 horizontal movement range that effects the vertical position of the traverse 23. Thus, the up/down bar 33 excludes movement of the optical disc loader 21 when the traverse 23 is in any other position than fully lowered.

In normal modes of operation, the horizontal position of the optical disc loader 21 and the vertical position of the traverse 23 are determined by a control system integral to the optical disc drive 10 via a motor (not shown in this view) and its associated sensors. More specifically, this facility provides an electro-mechanical means of lowering and raising the traverse 23 and locking, unlocking and sliding the optical disc loader 21, and of mechanically interlocking the relative movement of these elements.

FIG. 4 is a perspective view showing the optical disc drive of FIG. 3 with optical disc loader 21 removed for clarity and comprises an emergency release 41, an optical disc loader 21, a housing 22, a traverse 23, flexible mountings 31, a hinged linkage 32, an up/down bar 33, a spindle motor assembly 34, a motor 29 and gear train 44.

The emergency release 41, being formed from a geared quadrant pivoted on the housing 22 and having a rigid tab formed at the end displaying a recessed profile (42), is seen at the outward end of its travel, this being its position when the optical disc loader 21 is fully closed and locked. The emergency release 41 is constantly meshed with a geared portion formed on the up/down bar 33, and hence if the emergency release 41 rotates about its pivot point a corresponding horizontal movement of the up/down bar 33 must result, and vice-versa. The traverse 23, the vertical position of which is related to the horizontal position of the up/down bar 33 as described above, must be in the fully raised position as shown while the up/down bar 33 and hence emergency release 41, are in the respective positions shown in this figure. The motor 29 acts through the gear train 44 and forms part of the positional control system for the optical disc loader 21 and the traverse 23.

FIG. 5 is a perspective view showing the optical disc drive of FIG. 4, further comprising an instrument 51. This figure shows the emergency release 41 pushed to the inward end of its travel by the instrument 51. The relationship between the rotational position of the emergency release 41 and the horizontal position of the up/down bar 33 as described above, means that rotation of the emergency release 41 will force the up/down bar 33 to the horizontal position shown. Furthermore, because of the relationship between the vertical position of the traverse 23 and the horizontal position of the up/down bar 33 as described above, the traverse 23 must move correspondingly to the fully lowered position shown.

FIGS. 6, 7, 8 and 9 show a sensor arrangement for detecting horizontal position in three modes of operation, each comprising the same elements and those being an up/down bar 33 (shown in section), a detector switch 27, a housing 22 and a plate 26 (shown in section). The detector switch 27 further comprises two output pins, pin (a) 61 and pin (b) 62; the up/down bar 33 further comprises a cut out feature 63. For clarity, the up/down bar 33 and plate 26 are shown in section and the supporting structure, that is, the housing 22, is shown as a dotted line.

The detector switch 27 is a conventional three-position switch with a center-sprung toggle, sometimes in physical contact with the edges of a cut out feature 63 of the up/down bar 33, and sometimes in free space depending on the horizontal position of the up/down bar 33. In this case the sensor arrangement is implemented as above, although such arrangements are also commonly implemented by opto-electronic or inductive means.

FIG. 10 shows the output states of the sensor arrangement of FIGS. 6-9 and comprises an output plot for pin (a) 91, an output plot for pin (b) 93, a transition edge 92, and a transition edge 94. The output plots are demarked into three states, state (0) 95, state (1) 96 and state (2) 97.

FIG. 6 shows the interaction between the up/down bar 33 and the detector switch 27 when the up/down bar 33 is at the leftmost limit (viewed from the front of the optical disc drive 10) of its horizontal range, this corresponding to the following conditions:

1) Optical disc loader 21 fully closed and locked.

2) Traverse 23 at fully raised position.

3) The output of the detector switch 27 would correspond to state 0 (FIG. 10, demarcation 95 refers).

The above conditions normally prevail during disc access operations; it can be seen from FIG. 6 that the toggle of the detector switch 27 is deflected from a centered position by contact with an edge of the cut out feature 63 of the up/down bar 33.

FIG. 7 shows the interaction between the up/down bar 33 and the detector switch 27 following a small amount of rightwards movement of the up/down bar 33 (viewed from the front of the optical disc drive 10) such that the following conditions apply:

1) Optical disc loader 21 fully closed and locked.

2) Traverse 23 at fully raised position.

3) The output of the detector switch 27 would correspond to state 1 (FIG. 10, demarcation 96 refers).

The above conditions are an immediate prelude to the lowering of the traverse 23, as further horizontal movement of the up/down bar 33 in the same sense would have this effect as described above. It can be seen that, in this position, the cut out feature 63 of the up/down bar 33 allows the toggle of the detector switch 27 to resume its centered position and, as this happens, a transition edge 92 occurs on the output plot for pin (a) 91 forcing a state change from state (0) 95 to state (1) 96.

FIG. 8 shows the interaction between the up/down bar 33 and the detector switch 27 following further rightwards movement of the up/down bar 33 (viewed from the front of the optical disc drive 10) such that the following conditions apply:

1) Optical disc loader 21 unlocked and in any horizontal position except fully open or fully closed.

2) Traverse 23 at fully lowered position.

3) The output of the detector switch 27 would correspond to state 1 (FIG. 10, demarcation 96 refers).

Although the above conditions differ from those pertaining to FIG. 7, there is no further state change until the optical disc loader reaches the fully open position as described below.

FIG. 9 shows the interaction between the up/down bar 33 and the detector switch 27 following movement of the up/down bar 33 to the limit of its rightward travel (viewed from the front of the optical disc drive 10), such that the following conditions apply:

1) Optical disc loader 21 unlocked and fully open.

2) Traverse 23 at fully lowered position.

3) The output of the detector switch 27 would correspond to state 2 (FIG. 10, demarcation 97 refers).

It can be seen that for this position of the up/down bar 33, the toggle of the detector switch 27 is again deflected from a centered position by contact with an edge of the cut out feature 63, and that a transition edge 94 occurs on the output plot for pin (b) 93 forcing a state change from state (1) 96 to state (2) 97.

The progression from FIG. 6 to FIG. 9 describes a sequence of events that occurs as part of a process required to move the optical disc loader 21 from the fully closed to fully open position. Similarly, if the optical disc loader 21 were moved from the fully open to the fully closed position, then the same sequence would apply in reverse.

In normal mode, operation of the optical disc loader 21, whether it be to load or eject an optical disc, can be requested electrically by the user via an open/close request button 13, this generally being fitted to the optical disc drive fascia 12, or sometimes via a software interface, in which case the request would reach the micro-controller (not shown) of the optical disc drive via its interface with the host computer. In both of the above cases, the request is processed by the micro-controller according to the state output of the detector switch 27, that is, if state 0 exists then the optical disc loader 21 opening sequence is initiated, and if state 2 exists then the optical disc loader 21 closing sequence is initiated. The above account is simplified as other configurations of the controller and its sensors are possible at the point where an open/close request might be made, however, the object of this account is simply to detail the normal sequence of events constituting the optical disc loader 21 opening sequence.

However, an alternative means of opening the optical disc loader 21 is provided to allow emergency retrieval/ejection of optical discs from the optical disc drive 10 in the event of a power failure, device failure, or other malfunction effecting the operation of the motor 29.

Referring to FIG. 4, the optical disc drive additionally comprises an emergency release 41. The emergency release 41, this being a gear quadrant with a rigid tab formed at one end, is pivoted on the optical disc drive housing 22 and meshes with the gear rack formed on the up/down bar 33. Access to the rigid tab of the emergency release 41 is generally offered via an opening in the optical disc drive fascia panel (FIG. 1, item 15 refers), and operation of the emergency release 41 is generally by engaging the rigid tab with a suitable instrument (FIG. 5, item 51 refers) and moving said tab to the inward end of its travel, thus sliding the up/down bar 33. This action has the effect of lowering the transport mechanism 23, thus disengaging it from the optical disc, and subsequently unlocking the disc loader, allowing the user to open the disc loader by hand.

If the emergency release 41 were to be used inappropriately during an optical disc access operation, the spindle motor assembly 34 and hence, the optical disc, would be rotating at speed. As described above, the traverse 23 would be lowered, thus bringing the readable surface of the optical disc into contact with the optical disc loader recess 28. The optical disc loader recess 28 is not designed to safely accept a rotating optical disc, hence damage to the optical disc and further random effects detrimental to the operation of the optical disc drive could occur.

According to the prior art, the sensor (in this case detector switch 27) used to detect the positional status of the optical disc loader 21, is not monitored by the integral control system (micro-controller) during normal disc access operations, thus the integral control system would not detect the inappropriate operation of the emergency release, nor would it initiate remedial action.

Accordingly, there is a need to develop a method for reducing the possibilities of optical disc damage in an optical disc drive 10 in the event of inappropriate use of the emergency release.

### SUMMARY OF INVENTION

It is an object of the present invention to provide a method for rapidly returning the disc loader and traverse of an optical disc drive to their respective starting positions following inappropriate use of the emergency release facility.

In order to accomplish the object of the present invention, the present invention provides a method for monitoring and controlling the status of a coordinating mechanism responsible for the relative positions of an optical disc loader 21 and traverse 23 in an optical disc drive 10.

The output states of a sensor, these being used to monitor the position of the coordinating mechanism and hence the optical disc loader 21 and traverse 23 during normal operation, are monitored constantly. Should the coordinating mechanism (in this case the up/down bar 33) be found to be unexpectedly traveling in a direction that would cause the lowering of the traverse 23 and subsequent unlocking of the optical disc loader 21, the motor 29 is used to reverse the condition, hence minimizing potential damage to the optical disc.

These and other objectives of the claimed invention will no doubt become obvious to those of ordinary skill in the art after reading the following detailed description of the preferred embodiment that is illustrated in the various figures and drawings.

### BRIEF DESCRIPTION OF DRAWINGS

FIG. 1 illustrates the fascia of a conventional internal optical disc drive.

FIG. 2 is a partially exploded view of a conventional internal optical disc drive.

FIG. 3 is a perspective view of the conventional internal optical disc drive of FIG. 2, with fascia removed and optical disc loader extended to the fully open position.

FIG. 4 is a perspective view of the conventional internal optical disc drive of FIG. 2 with the fascia and optical disc loader removed and illustrating the traverse in a raised position.

FIG. 5 is a perspective view of the conventional internal optical disc drive of FIG. 2 with the fascia and optical disc loader removed and illustrating the traverse in a lowered position.

FIGS. 6, 7, 8 and 9 show a sensor arrangement for detecting the horizontal position of a coordinating mechanism in three modes and at four key points of operation.

FIG. 10 shows the output states of the sensor arrangement of FIGS. 6-9.

FIG. 11 is a flow diagram of the method of the present invention.

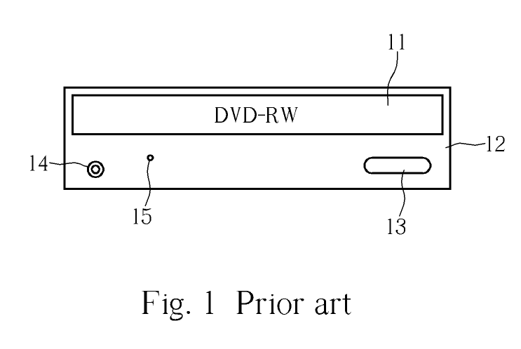

### DETAILED DESCRIPTION

Although the embodiments of the present invention are described below in connection with internal DVD-ROM drives, the present invention can be applied to all optical disc drive types featuring a servo operated optical disc loader, including but not limited to CD-ROM drives, CD-R/RW drives, DVD-RAM drives, DVD-R/RW drives, DVD+R/RW drives, COMBO drives, car audio players, external drives, as well as all other optical media recorders and players

According to the prior art, the output states of the detector switch 27 are only considered when the optical disc loader 21 is opened or closed, this generally taking place upon a request to a micro-controller from a user via an open/close request button 13, or from a host computer via an interface. Before acting upon a request to open the optical disc loader 21, however derived, the micro-controller will first interrogate the state of the traverse 23; if an optical disc is being accessed at the time of the open request, the micro-controller will usually cancel the optical disc access process and wait until the spindle motor, and hence the optical disc, has stopped rotating before allowing the motor 15 to drive the up/down bar 33 as to lower the traverse 23 and subsequently unlock and open the optical disc loader 21.

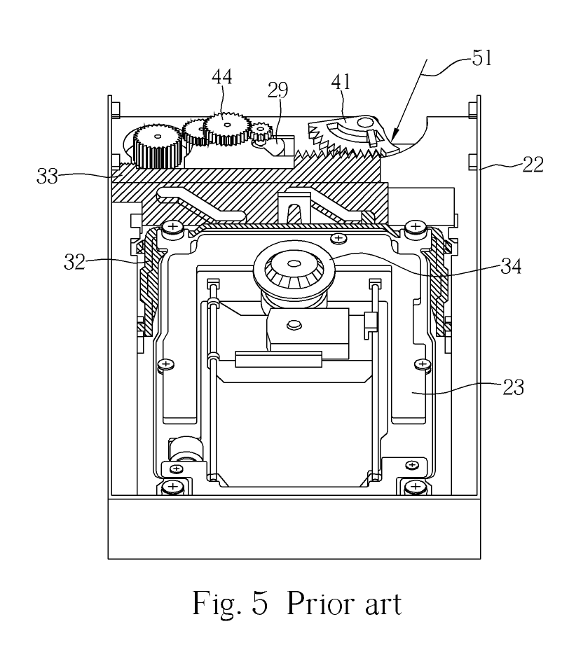

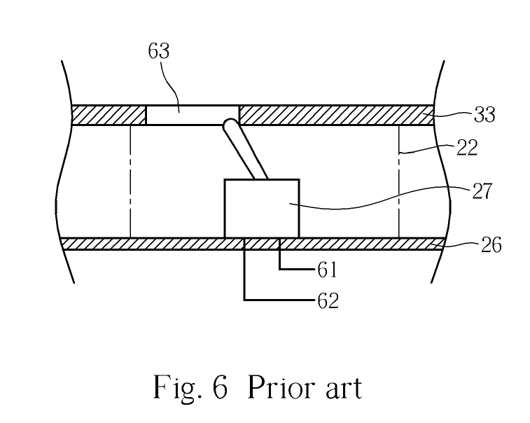

Also according to the prior art if, referring to FIG. 5, the emergency release 41 is rotated during an optical disc access process, then, in contrast to the micro-controller supervised process detailed above, the traverse 23 would be lowered and the optical disc loader (not shown in FIG. 5) would be unlocked while the spindle motor assembly 34, and hence an optical disc, were still rotating.

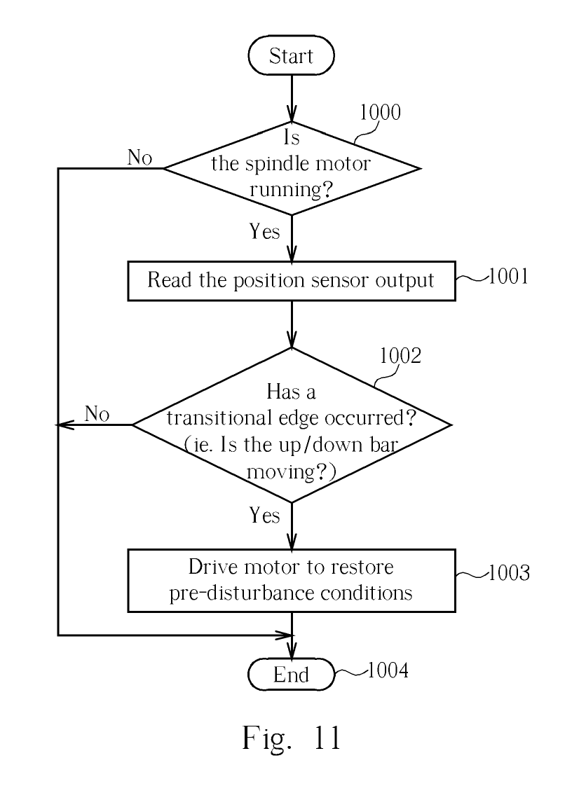

In contrast to the prior art, the present invention provides the optical disc drive 10 with an additional procedure for mechanical and electronic coordination so as to solve the problems of the prior art. A routine with the following functional steps (FIG. 11 refers) is embodied into the control routine governing optical disc access processes:

1000 Is the spindle motor assembly rotating? If ‘yes’ then proceed to step 1001. Otherwise, proceed to step 1004.

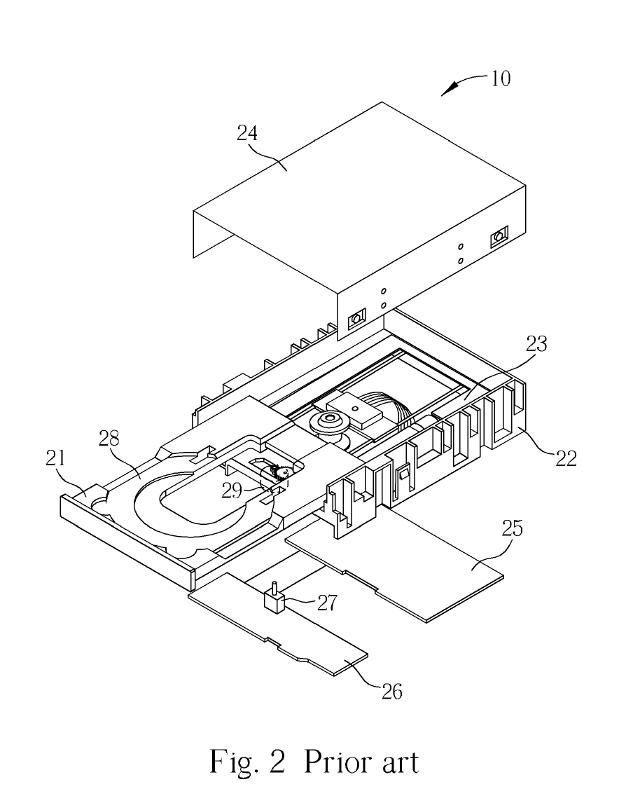

1001 Read detector switch (FIG. 2, item 27 refers) output.

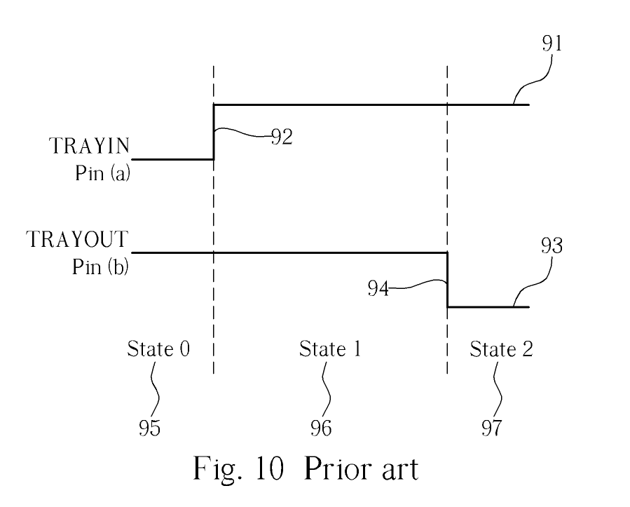

1002 Does detector switch 27 output feature a transition edge (FIG. 10, item 92 refers)? If ‘yes’ then proceed to step 1003. Otherwise, proceed to step 1004.

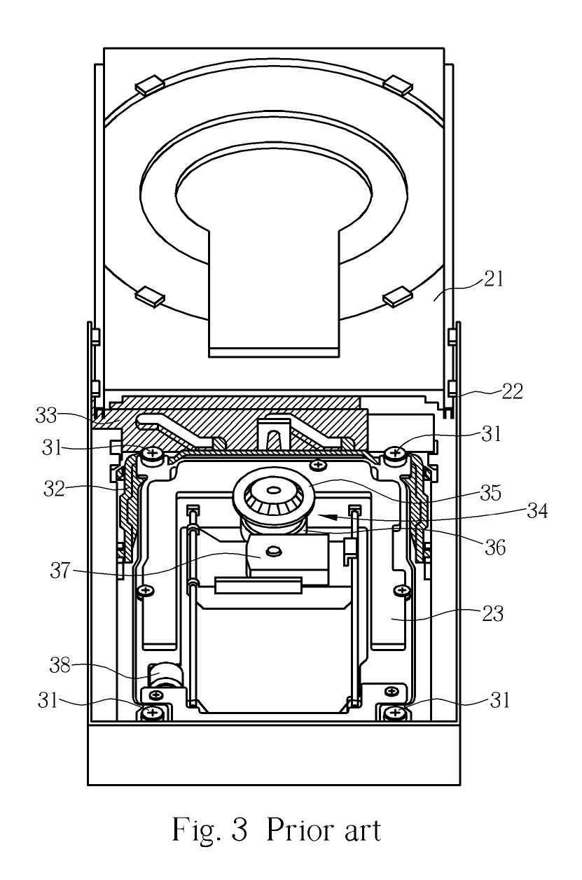

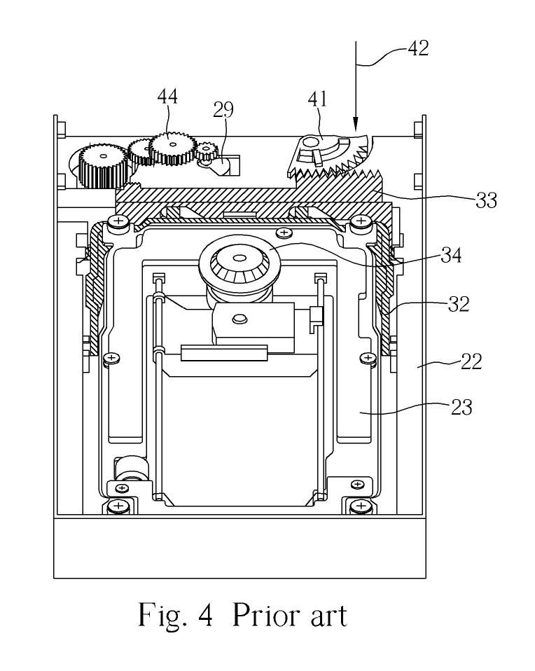

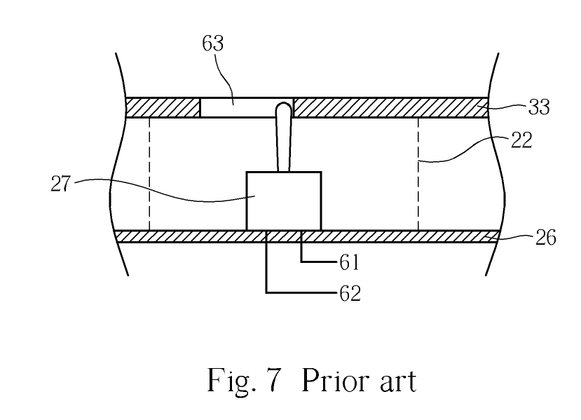

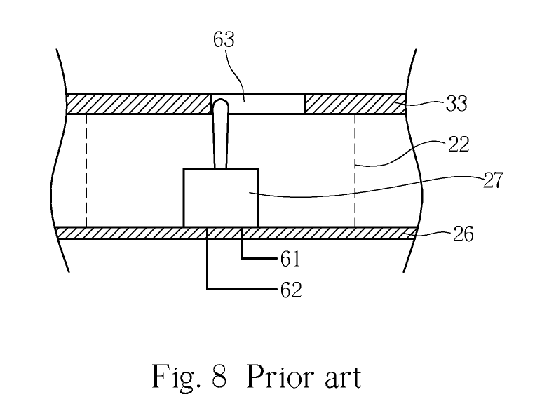

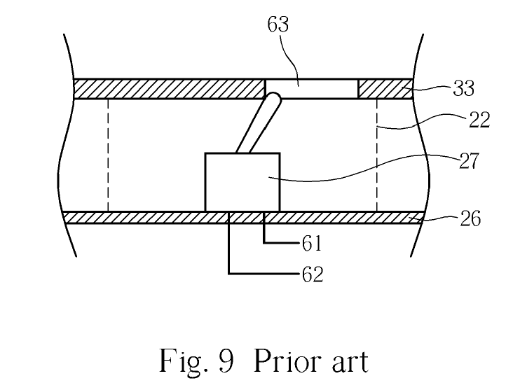

1003 Instruct motor (FIG. 4, item 43 refers) to drive as to restore the up/down bar (FIG. 3, item 33), and therefore the optical disc loader and the traverse (FIG. 2, items 21 & 23 respectively refer), to an initial position, that being a position that would satisfy the conditions described by FIG. 7.

1004 Exit the routine.

The above routine, being a set of instructions, may be implemented by more arcane means but given the state of the art, would normally take the form of software/firmware code for an embedded micro-controller or similar device. In optical disc drives with lower levels of autonomy, the routine would again take the form of software/firmware code, residing wherever supervisory routines were processed.

1. A method for controlling a disc loader of an optical disc drive, comprising the following steps:
detecting an activation of an emergency release when the disc loader is at a fully closed position and the optical drive is in an access process; and
driving the disc loader to the fully closed position if the emergency release is activated.

2. The method of claim 1, wherein the activation of the emergency release is sensed by a sensor sensing a movement of a locking mechanism.

3. The method of claim 2, wherein the locking mechanism is an up/down bar.

4. An optical disc drive comprising:
a housing;
a traverse installed inside the housing;
a disc loader slidably installed inside the housing;
a sensor for detecting a movement of the traverse or the optical disc loader; and
a motor for driving the optical disc loader to a fully closed position when the optical drive is in an access process and the movement is detected.

5. The optical disc drive of claim 4, wherein the optical disc drive further comprises an emergency release for releasing the optical loader from the fully closed position if the emergency release is activated.

6. A method for controlling a disc loader of an optical disc drive, comprising the following steps:
detecting a movement of a traverse or the disc loader when the disc loader is at a fully closed position and the optical disc drive is in an access process; and
driving the disc loader to the fully closed position if the movement is detected.

7. The method of claim 6, wherein when an emergency release is activated the movement of the traverse or the disc loader is caused.
